(19) United States
(12) Patent Application Publication
(10) Pub. No.: US 2012/0317854 A1
(43) Pub. Date: Dec. 20, 2012

(54) Offhand Recoil Grip

(76) Inventor: Robert Chester Nierenberg, Honolulu, HI (US)

(21) Appl. No.: 13/163,649

(22) Filed: Jun. 17, 2011

(51) Int. Cl. F41C 23/06; B23C 3/00; B23Q 15/00; F41C 23/10

(52) U.S. Cl. 42/1.06; 409/131; 409/80

(57) ABSTRACT

An offhand recoil grip is described. In one disclosed embodiment, a recoil grip has a mounting portion to connect to a grip mount of a handgun, the mounting portion further having an offset support portion extending from the mounting portion toward the top and front of the handgun, the offset support portion having a second planar surface offset from the first planar surface of the mounting portion to allow a slide to move between the recoil grip and a receiver of the handgun, and a lateral grip pad coupled to the offset support portion, the lateral grip pad extending laterally away from the grip mount of the handgun to provide a thumb contact point for a non-trigger hand to reduce recoil in a handgun when fired. Other embodiments are described involving a method of using a recoil grip, recoil grips with different attachments, for different weapons, etc.

### BACKGROUND

1. Field of the Invention

The invention relates to a grip for a handgun or rifle. More specifically the invention relates to a grip that counters recoil.

2. Prior Art

When a gun is discharged, it is propelled backward in a motion commonly referred to as recoil. Depending on the size and type of a gun, recoil can detrimentally impact the aim of a subsequent shot from the gun. For example, a large caliber handgun will have significant recoil which will rotate the handgun up and over the hand of a shooter, resulting in the shooter needing to then orient the handgun to aim back at an intended target. Rifles are also subject to detrimental impacts on aim for subsequent shots due to their large caliber, due to repeating rifles like semi-automatic or fully-automatic weapons, smaller stocks used in urban assault or sport settings, and the like.

### SUMMARY

Accordingly, an improved method and apparatus for an offhand recoil grip is described below in the Detailed Description. For example, one disclosed embodiment provides a recoil grip having a mounting portion including a plurality of holes, where each of the plurality of holes defines a surface extending through the mounting portion to receive a fastener to couple the mounting portion to a grip mount of a handgun, the mounting portion having a first planar surface to contact the grip mount of the handgun when the mounting portion is fastened to the handgun, the mounting portion further having a front portion oriented toward the barrel side of the handgun and a rear portion oriented toward the back of the grip mount of the handgun. The recoil grip also having an offset support portion extending from the mounting portion toward the top and front of the handgun, the offset support portion having a second planar surface offset from the first planar surface of the mounting portion to allow a slide to move between the recoil grip and a receiver of the handgun, and a lateral grip pad coupled to the offset support portion, the lateral grip pad extending laterally away from the grip mount of the handgun to provide a thumb contact point for a non-trigger hand to reduce recoil in a handgun when fired. Other embodiments are described involving a method of using a recoil grip, recoil grips with different attachments, for different weapons, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a side elevation view of a first embodiment of a recoil grip mounted on an M1911 pistol frame.

FIG. 2 shows a perspective view of the first embodiment of a recoil grip mounted on an M1911 pistol frame.

FIG. 3 shows a rear elevation view of the first embodiment of a recoil grip mounted on an M1911 pistol frame.

FIG. 4 shows a top elevation view of the first embodiment of a recoil grip mounted on an M1911 pistol frame.

FIG. 5 shows a bottom elevation view of the first embodiment of a recoil grip mounted on an M1911 pistol frame.

FIG. 6 shows a perspective view of a dovetail embodiment of a recoil grip.

FIG. 7 shows an end elevation view of the dovetail embodiment of a recoil grip.

FIG. 8 shows a side elevation view of the dovetail embodiment of a recoil grip mounted on an M1911 pistol frame.

FIG. 9 shows a bottom elevation view of the dovetail embodiment of a recoil grip mounted on an M1911 pistol frame.

FIG. 10 shows a side elevation view of a frame bump embodiment of a recoil grip mounted on a GLOCK pistol frame.

FIG. 11 shows a top elevation view of the frame bump embodiment of a recoil grip mounted on a GLOCK pistol frame.

FIG. 12 shows an offset perspective view of a picatinny rail embodiment of a recoil grip.

FIG. 13 shows a side elevation view of the picatinny rail embodiment of a recoil grip mounted on a SIG SAUER pistol frame.

FIG. 14 shows a perspective view of a picatinny rail embodiment of a recoil grip for a rifle.

FIG. 15 shows an end elevation view of the picatinny rail embodiment of a recoil grip for a rifle.

FIG. 16 shows a side elevation view of an ambidextrous embodiment of a recoil grip.

FIG. 17 shows a bottom perspective view of the ambidextrous embodiment of a recoil grip.

FIG. 18 shows an elevated view of the ambidextrous embodiment of a recoil grip.

FIG. 19 shows a flowchart diagram of a method of milling an offhand recoil grip.

### DETAILED DESCRIPTION

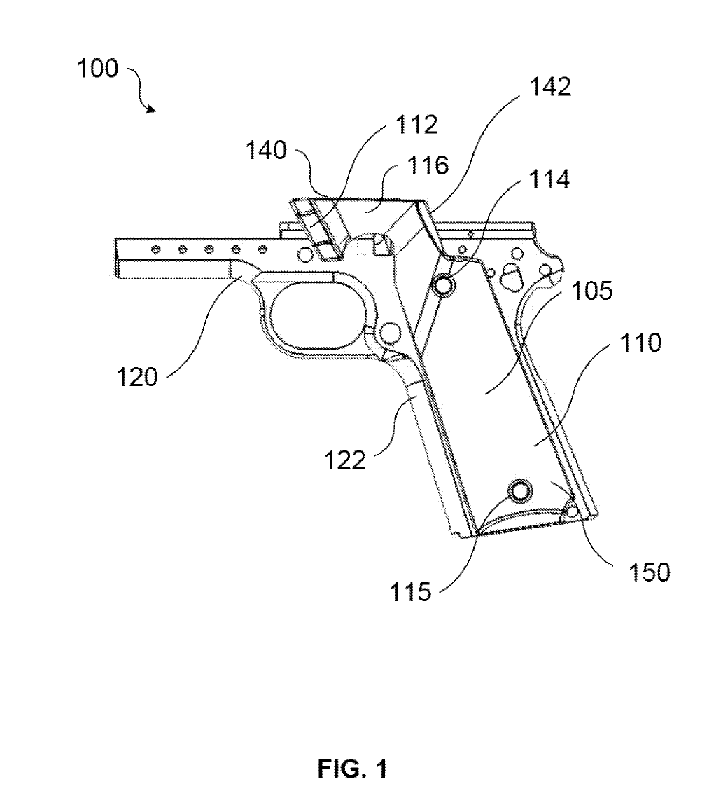

FIG. 1 shows a side elevation view of a first embodiment of a recoil grip 110 mounted on an M1911 pistol frame of handgun 120. Generally, a recoil grip may be affixed through established fastening locations, with a picatinny rail, to a frame, through a dovetail attachment, or any other suitable permanent, semi-permanent or adjustable connection to a handgun, a rifle, or other weapon.

In the embodiment depicted in FIG. 1, an offhand recoil grip 110 is shown comprising a mounting portion 105 including a plurality of holes 114 and 115, where each of the plurality of holes defines a surface extending through the mounting portion 105 to receive a fastener to couple the mounting portion 105 to a grip mount 122 of a handgun. For example, the plurality of holes may comprise two holes such as for an M1911 pistol to then allow fastening through the factory grip attachments. In other embodiments the lateral grip pad may have a number of holes corresponding to other handgun grip attachments, or may even have additional or less holes, to allow a wider range of attachment mechanisms. In some embodiments, holes 114 and 115 are slots to allow adjustment of the offhand recoil grip 110 on a handgun frame.

With reference to the embodiment in FIG. 1, the mounting portion 105 has a first planar surface 119 (as shown in FIG. 3) to contact the grip mount 122 of the handgun when the mounting portion 105 is fastened to the handgun. The mounting portion 105 has a front portion 140 oriented toward the barrel side of the handgun and a rear portion 150 oriented toward the back of the grip mount 122 of the handgun. In some embodiments an offset support portion 116 extends from the mounting portion 105 toward the top and front of the handgun, with the offset support portion 116 further having a second planar surface 118 (shown in FIG. 3) offset from the first planar surface 119 of the mounting portion 105 to allow a slide to move between the recoil grip 110 and a receiver of the handgun 120. In some embodiments, the offhand recoil grip comprises a monolithic structure. By way of example, the offhand recoil grip may be milled from a single piece of aluminum or other suitable grip materials. For example, the offhand recoil grip may be milled or injection molded reinforced polymer, light weight metals, alloys, or may be cast or case-hardened or heat treated steel, as well as other suitable grip materials.

In some embodiments, recoil grip 110 includes a lateral grip pad 112 coupled to the offset support portion 116, the lateral grip pad extending laterally away from the grip mount of the handgun to provide a thumb contact point for a non-trigger hand to reduce recoil in a handgun when fired. In some embodiments, the lateral grip pad 112 is positioned between a slide stop spindle axis of the handgun and the grip mount of the handgun.

In the embodiment depicted in FIG. 1, the lateral grip pad 112 has a contoured surface 140 to control recoil flip and to control windage. In this way, at least a portion of lateral grip pad 112 or offset support portion 116 may have a contour or surface texture to provide control on the handgun in addition to recoil control. In this way, the recoil grip can be used to control elevation changes due to recoil, to control windage, or to control any combination of these two elements as well as other rotations or movements of the handgun. Contoured surface 140 enables the strong flexors and radial deviators of an off-hand thumb to oppose the forces applied from palmar surfaces of the index through ring fingers of the off-hand as well as to oppose the shooting hand palmar surfaces to improve gripping leverage and to counter recoil induced torque on a handgun. In some embodiments, lateral grip pad 112 is placed close to the bore axis of the handgun barrel to reduce the counter torque required to control flip. Contour 140 naturally positions the thumb to point slightly inward and thus placing a vector of counter force from the thumb in a slightly inward direction toward the handgun. Therefore, contour 140 and lateral grip pad 112 can coordinate to provide control in all three axes of recoil components, including flip, windage or yaw error, and twist or barrel axial rotation. Further, by increasing control of the handgun with the off-hand, a shooter can relax their shooting hand and thereby improve trigger control.

In some embodiments, the offhand recoil grip may further comprise a thumb rest 142 for the triggering hand. For example, the thumb rest 142 for the triggering hand may be a surface on the back of the offset support portion 116. In this way, a user of the handgun can place either their offhand thumb on lateral grip pad 112 or the thumb of their triggering hand on thumb rest 142. The present embodiment is shown for a right-handed shooter, but some embodiments may be used on the opposite side of a handgun for a left-handed shooter.

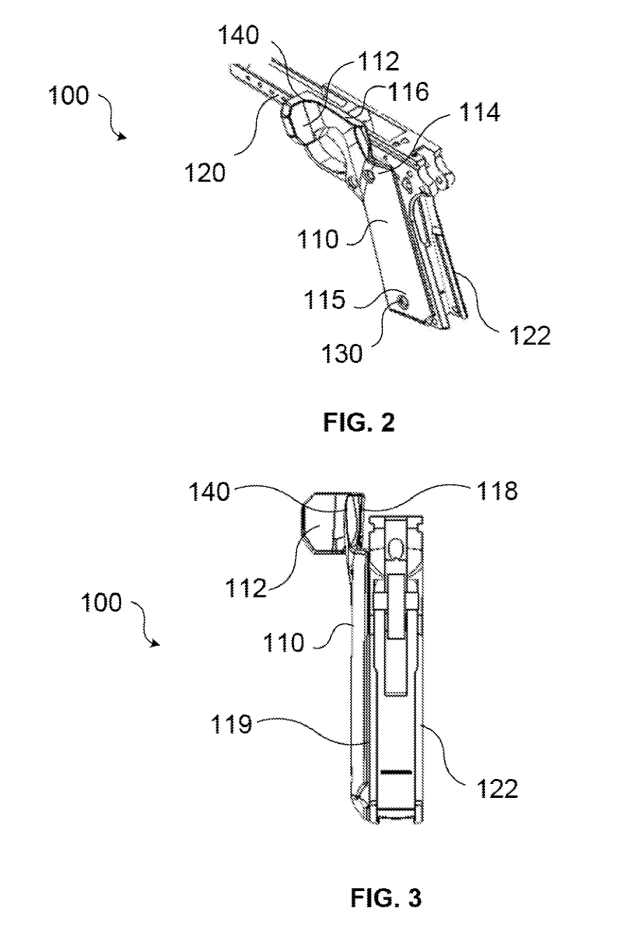

FIG. 2 shows a perspective view of the first embodiment of a recoil grip mounted on an M1911 pistol frame as also shown in FIG. 1. In this view, the contoured surface 140 can be seen from a different angle as a curved surface between lateral grip pad 112 and offset support portion 116. Additionally, screw 130 is shown placed through the surface defined by hole 115 to connect the mounting portion 105 or recoil grip 110 to the grip mount 122 of a handgun, however other embodiments are not limited in this way. For example, a recoil grip may be bonded to a grip mount 122 of handgun while still allowing offset support portion 116 to not interfere with field stripping the handgun.

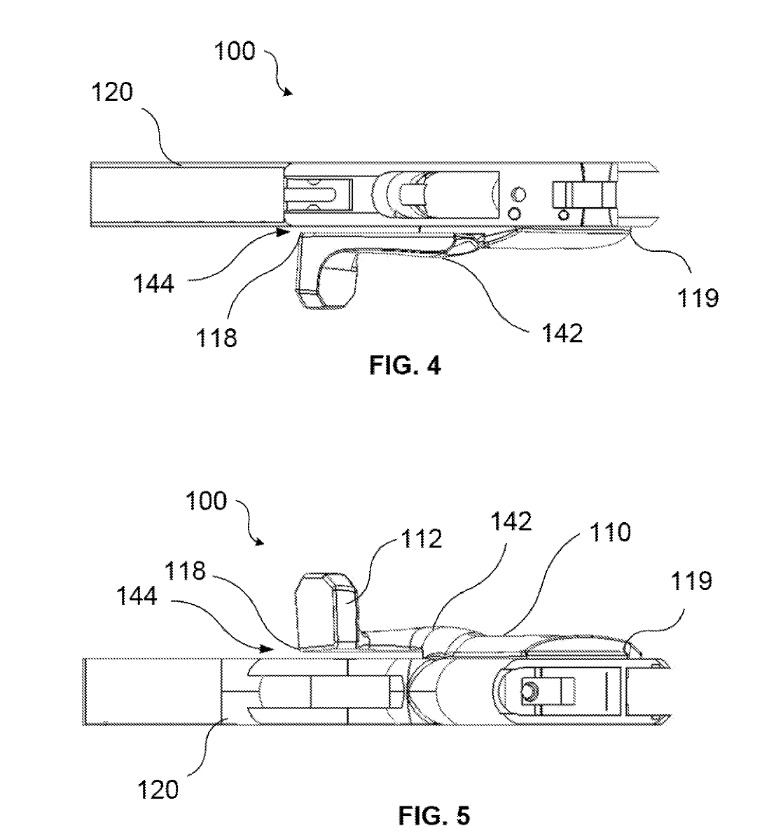

FIGS. 3-5 show a rear elevation view, a top elevation view, and a bottom elevation view of the first embodiment of recoil grip 110 mounted on an M1911 pistol frame. FIG. 3 shows a first planar surface 119 to contact the grip mount 122 of the handgun when the recoil grip 110 is fastened to the handgun. A second planar surface 118 is also shown on the handgun side of offset support portion 116, where the second planar surface 118 is offset from the first planar surface 119 to allow clearance for a slide for handgun 120 to move between the receiver of handgun 120 and recoil grip 110. FIG. 4 and FIG. 5 illustrate a gap 144 between the second planar surface 118 of offset support portion 116 and the handgun 120. Additionally, FIGS. 4-5 illustrate an additional contour 142 of offset support portion 116 that works in conjunction with contour 140 to provide additional control over handgun for windage, elevation, rotation, etc.

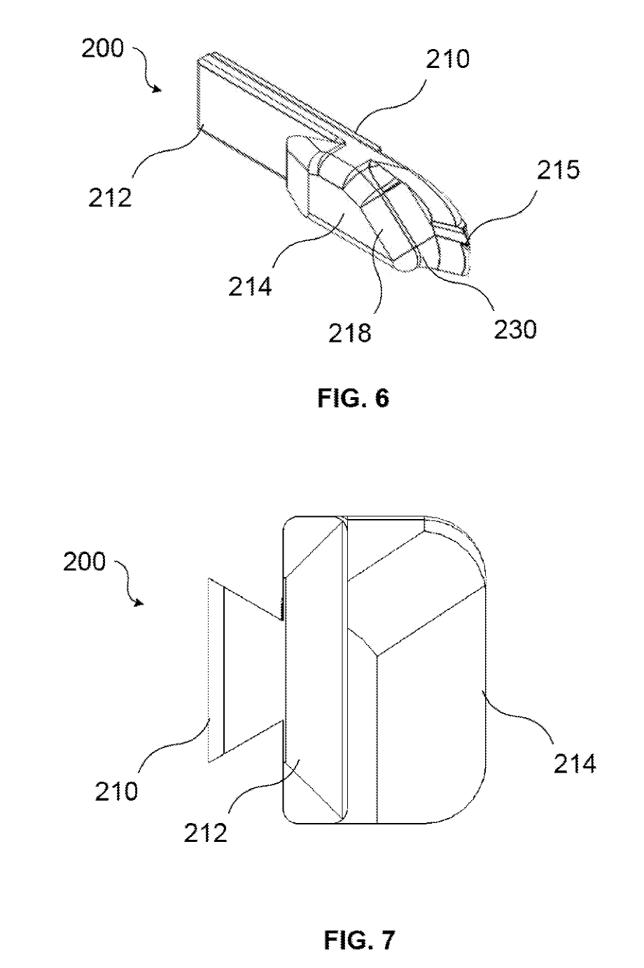

FIG. 6 shows a perspective view of a dovetail recoil grip 200 having a front end 212 and a back end 215. The dovetail embodiment has a lateral grip pad 218 on a lateral protrusion 214. The present embodiment also has a dovetail attachment 210 as shown more clearly in FIG. 7 from a view looking directly at the front end 212 of dovetail recoil grip 200. Dovetail recoil grip 200 also has a contoured portion 230 connecting lateral grip pad 218 with the main body of the recoil grip. FIG. 9 shows a bottom view of the contoured portion 230. Contoured portion 230 assist in control of windage as well as elevation in similar fashion to contour 140 in the embodiment depicted in FIG. 1.

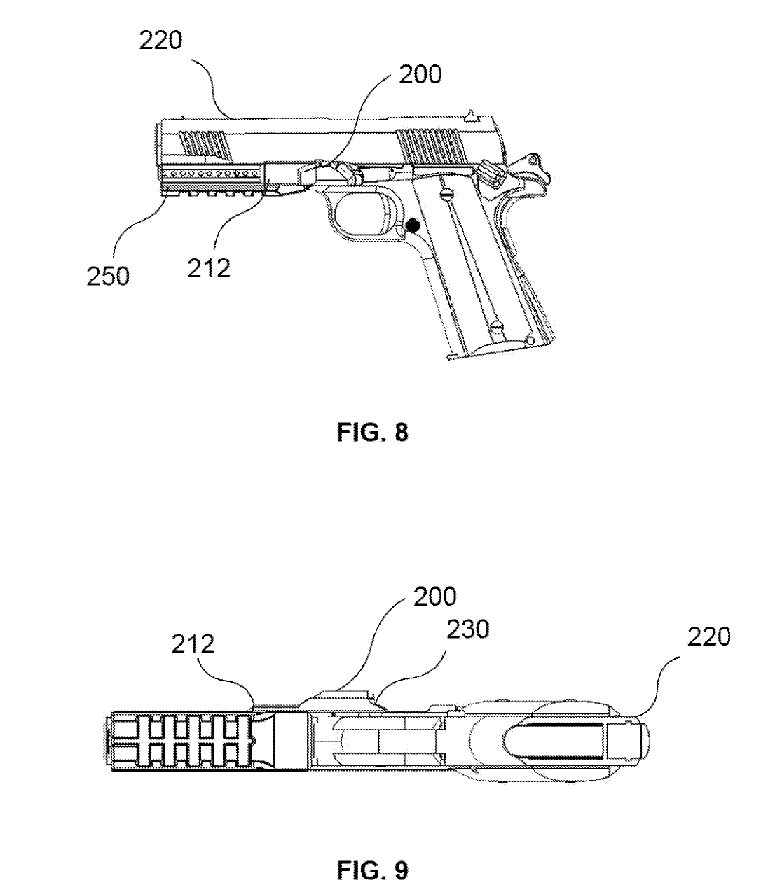

FIG. 8 shows a side elevation view of the dovetail recoil grip 200 mounted on an M1911 pistol 220. Pistol 220 includes a dovetail groove 250 for affixing additional components. The dovetail attachment 210 of dovetail recoil grip 200 fits within dovetail groove 250 with the front end 212 of the recoil grip positioned toward the front of the barrel of pistol 220 such that lateral grip pad 218 and contoured portion 230 face the back of pistol 220 to allow an offhand thumb rest to control pistol 220.

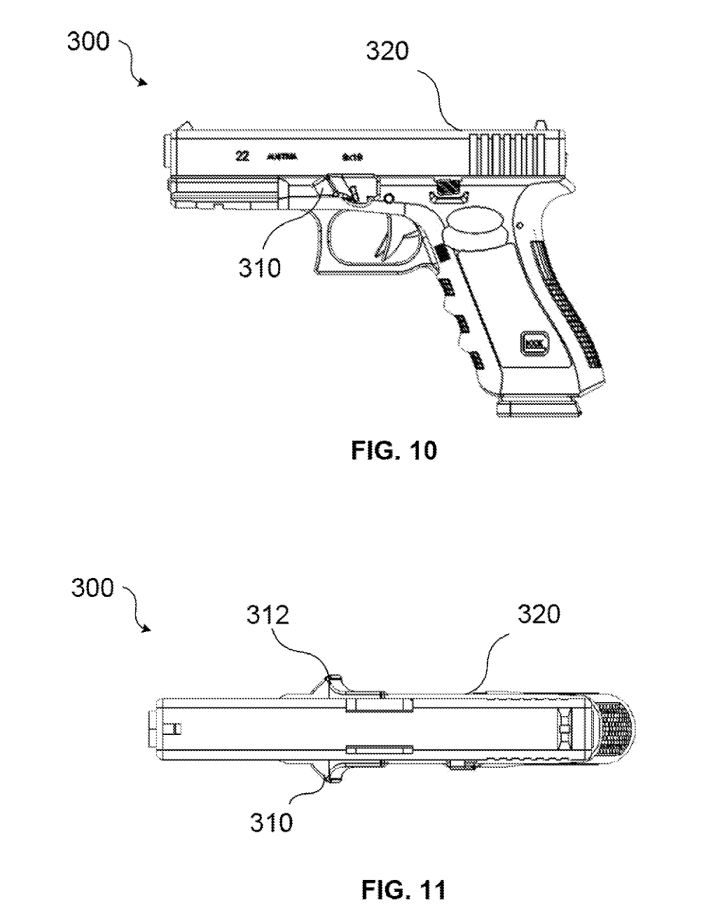

FIG. 10 shows a side elevation view of a frame bump 310 recoil grip mounted on a GLOCK pistol frame 320. A frame bump 310 embodiment is connected directly to the frame of a handgun or rifle and allows placement of a recoil grip in custom places such as were there is no picatinny rail, no dovetail attachment, away from factory mounting places in general. Frame bump 310 may comprise contoured sections and one or more grip pads as described with respect to other embodiments disclosed herein. FIG. 11 illustrates two recoil grips, frame bump 310 and frame bump 312, as may be used in some embodiments, but other embodiments are not so limited and a frame bump may be used on one side of the handgun frame. Additionally, a frame bump may be attached to the handgun frame through screws, rails, bonding, or other techniques, or a frame bump may be an off-hand recoil grip that is part of a monolithic structure of the handgun frame.

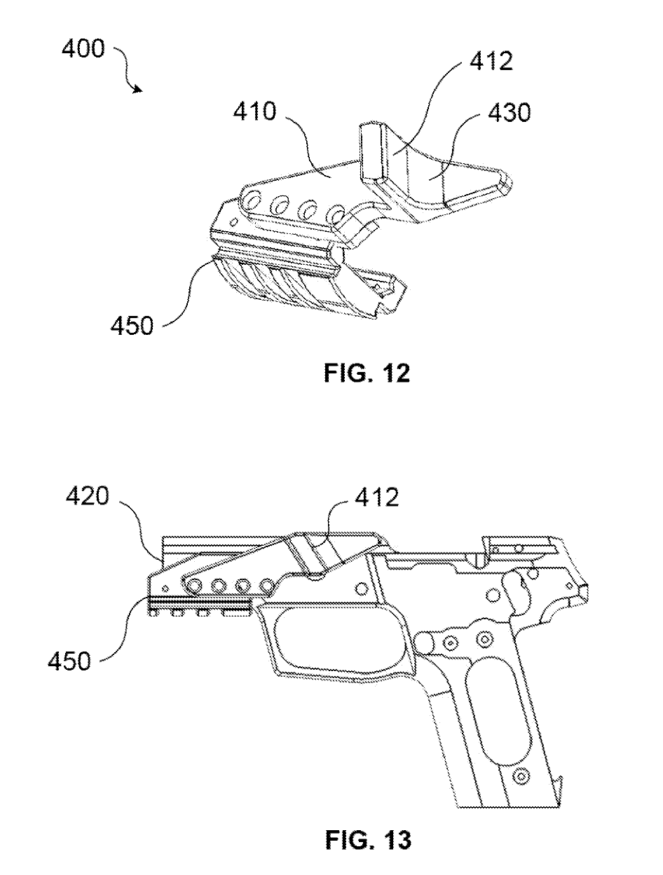

FIGS. 12-13 show an embodiment of a picatinny rail recoil grip 400 for a handgun. Picatinny rail recoil grip 400 includes a picatinny rail attachment 450, a lateral grip pad 412 and a contoured section 430. In some embodiments, picatinny rail recoil grip 400 may comprise separate components for picatinny rail attachment 450 and recoil grip 410. In this way an offhand recoil grip may be interchanged with another offhand recoil grip and connected to a handgun using the same picatinny rail attachment 450.

By way of example, a recoil grip having a different geometry may be interchanged. In this way, the lateral grip pad 412 may be in a different place for different shooting uses, for different users hand sizes and a different contoured section 430 may be used to provide a tailored control of windage, elevation, etc. while using the same picatinny rail attachment. In other embodiments the picatinny rail recoil grip 400 may have a monolithic structure. FIG. 13 shows picatinny rail recoil grip 400 affixed to a frame of handgun 420.

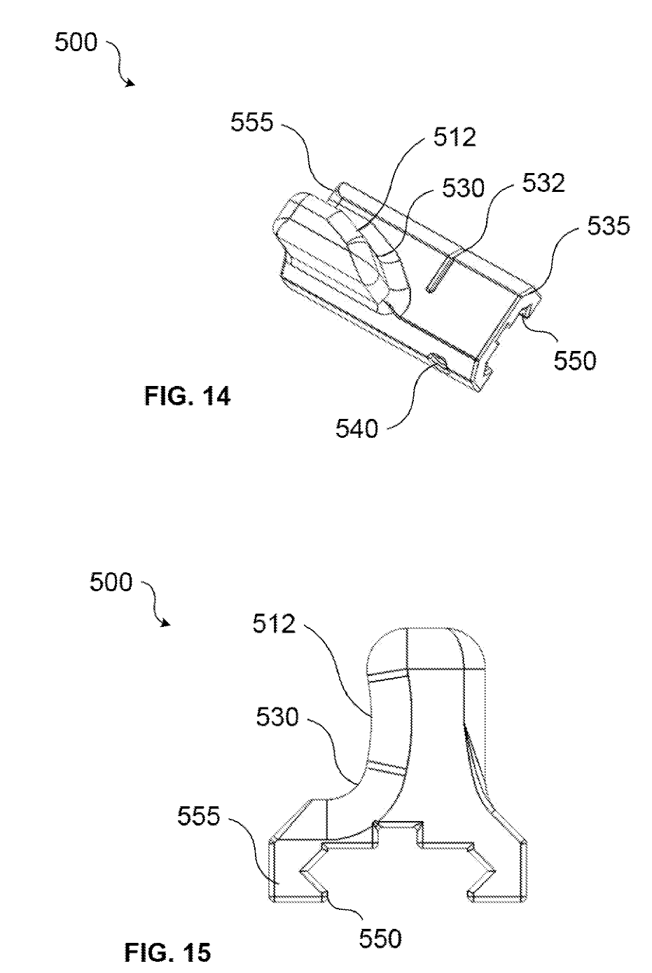

FIGS. 14-15 show a picatinny rail recoil grip 500 for a rifle. In some embodiments, picatinny rail recoil grip 500 has a lateral grip pad 512, a contoured section 530 in similar fashion to other embodiments described herein, a front end 555 and a back end 535, and a flex slot 532. Recoil grip 500 also has a picatinny rail attachment 550 as shown in FIG. 15 from front end 555. Picatinny rail recoil grip 500 also has an attachment screw 540 for fixedly connecting the recoil grip within a picatinny rail attachment of a rifle.

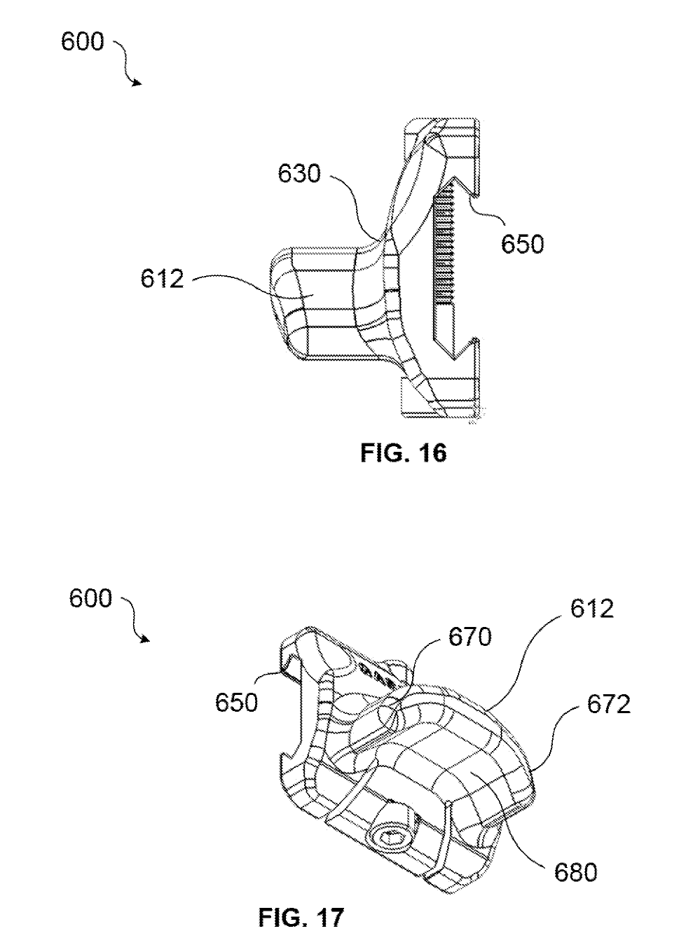

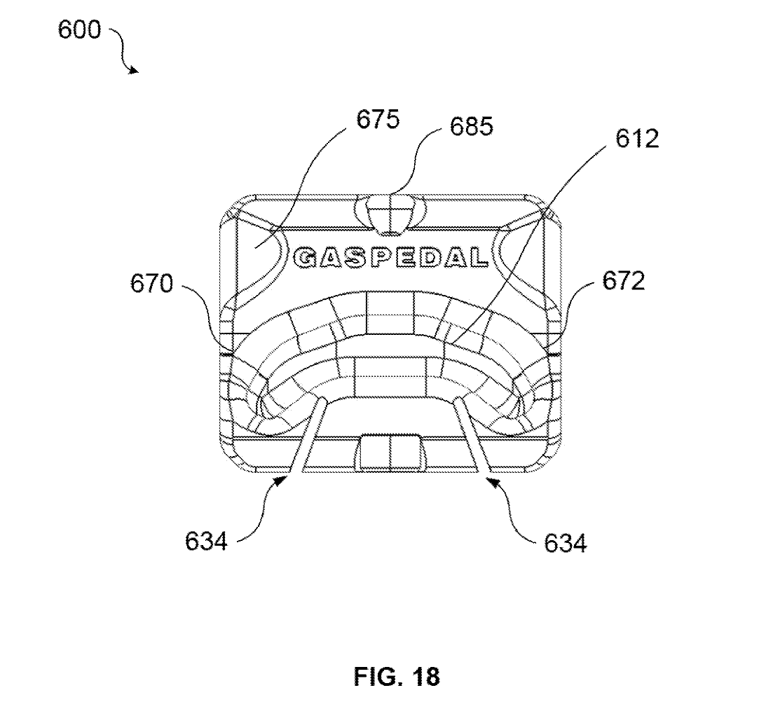

FIGS. 16-18 shows an ambidextrous picatinny rail recoil grip 600. Recoil grip 600 includes a lateral protrusion 612 further including a first lateral grip pad 670 and a second lateral grip pad 672. In some embodiments, lateral protrusion 612 has a concave portion 680 on one side to provide another contact for the hand of a user. In this way, recoil grip 600 may be placed on a picatinny rail or other attachment to allow for right-handed or left-handed shooting with the same recoil grip. Recoil grip 600 is also shown with two angled flex slots 634 to allow recoil grip 600 to flex slightly when affixed to a picatinny rail with a fastening screw or other tension attachment mechanism. Further, recoil grip 600 includes contoured section 675 to receive an off-hand thumb and provide three axis control in similar fashion to contoured surface 140 in the embodiment described in FIG. 1.

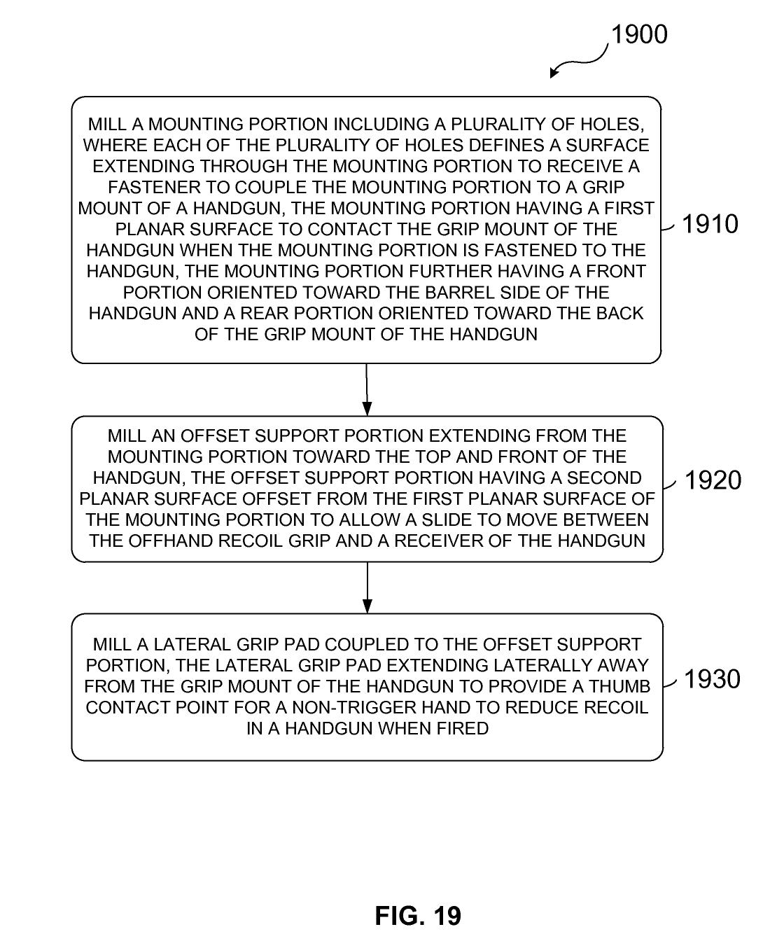

FIG. 19 shows a flowchart diagram of a method 1900 of milling an offhand recoil grip. For example, a method may involve making an offhand recoil grip using computer numerical controlled milling, but other embodiments are not so limited and an offhand recoil grip may be milled or made using other suitable methods. Additionally, an offhand recoil grip may be milled from a single piece of material as explained hereinabove with reference to other embodiments, but other embodiments may be a combination of multiple pieces with at least one of the combination of pieces being milled.

With reference to the figure, method 1900 includes milling a mounting portion including a plurality of holes, where each of the plurality of holes defines a surface extending through the mounting portion to receive a fastener to couple the mounting portion to a grip mount of a handgun, the mounting portion having a first planar surface to contact the grip mount of the handgun when the mounting portion is fastened to the handgun, the mounting portion further having a front portion oriented toward the barrel side of the handgun and a rear portion oriented toward the back of the grip mount of the handgun in block 1910. In the depicted embodiment, the plurality of holes comprises two holes, but other embodiments are not limited to two holes.

Then in block 1920, method 1900 then includes milling an offset support portion extending from the mounting portion toward the top and front of the handgun, the offset support portion having a second planar surface offset from the first planar surface of the mounting portion to allow a slide to move between the offhand recoil grip and a receiver of the handgun. In some embodiments, a thumb rest for the triggering hand may be milled into a surface on the back of the offset support portion.

Method 1900 then includes milling a lateral grip pad coupled to the offset support portion, the lateral grip pad extending laterally away from the grip mount of the handgun to provide a thumb contact point for a non-trigger hand to reduce recoil in a handgun when fired. In some embodiments, lateral grip pad and offset portion may have a contoured surface to control recoil flip and to control windage. In some embodiments, the lateral grip pad is positioned at the back of the grip mount in relation to a slide stop spindle axis of the handgun. It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. An offhand recoil grip comprising:
a mounting portion including a plurality of holes, where each of the plurality of holes defines a surface extending through the mounting portion to receive a fastener to couple the mounting portion to a grip mount of a handgun, the mounting portion having a first planar surface to contact the grip mount of the handgun when the mounting portion is fastened to the handgun, the mounting portion further having a front portion oriented toward the barrel side of the handgun and a rear portion oriented toward the back of the grip mount of the handgun;
an offset support portion extending from the mounting portion toward the top and front of the handgun, the offset support portion having a second planar surface offset from the first planar surface of the mounting portion to allow a slide to move between the recoil grip and a receiver of the handgun; and
a lateral grip pad coupled to the offset support portion, the lateral grip pad extending laterally away from the grip mount of the handgun to provide a thumb contact point for a non-trigger hand to reduce recoil in a handgun when fired.

2. The offhand recoil grip of claim 1, wherein the lateral grip pad is positioned between a slide stop spindle axis of the handgun and the grip mount of the handgun.

3. The offhand recoil grip of claim 1, wherein the lateral grip pad has a contoured surface to control recoil flip and to control windage.

4. The offhand recoil grip of claim 1, wherein the plurality of holes comprises two holes.

5. The offhand recoil grip of claim 1, wherein the grip comprises a monolithic structure.

6. The offhand recoil grip of claim 5, wherein the grip is milled from a single piece of aluminum.

7. The offhand recoil grip of claim 1, further comprising a thumb rest for the triggering hand.

8. The offhand recoil grip of claim 7, wherein the thumb rest for the triggering hand is a surface on the back of the offset support portion.

9. A method of making an offhand recoil grip from a single piece of material, the method comprising:
milling a mounting portion including a plurality of holes, where each of the plurality of holes defines a surface extending through the mounting portion to receive a fastener to couple the mounting portion to a grip mount of a handgun, the mounting portion having a first planar surface to contact the grip mount of the handgun when the mounting portion is fastened to the handgun, the mounting portion further having a front portion oriented toward the barrel side of the handgun and a rear portion oriented toward the back of the grip mount of the handgun;
milling an offset support portion extending from the mounting portion toward the top and front of the handgun, the offset support portion having a second planar surface offset from the first planar surface of the mounting portion to allow a slide to move between the offhand recoil grip and a receiver of the handgun; and
milling a lateral grip pad coupled to the offset support portion, the lateral grip pad extending laterally away from the grip mount of the handgun to provide a thumb contact point for a non-trigger hand to reduce recoil in a handgun when fired.

10. The method of claim 9, wherein the milling is computer numerical controlled milling.

11. The method of claim 9, wherein the lateral grip pad is positioned at the back of the grip mount in relation to a slide stop spindle axis of the handgun.

12. The method of claim 9, wherein the thumb rest has a contoured surface to control recoil flip and to control windage.

13. The method of claim 9, wherein the plurality of holes comprises two holes.

14. The method of claim 9, wherein the grip is milled from a single piece of aluminum.

15. The method of claim 9, further comprising milling a thumb rest for the triggering hand into a surface on the back of the offset support portion.
